(19) United States
(12) Patent Application Publication
(10) Pub. No.: US 2024/0425755 A1
(43) Pub. Date: Dec. 26, 2024

(54) SOIL IMPROVER

(71) Applicant: GREEN GEOEARTH GMBH, Erftstadt (DE)

(72) Inventors: Dirk BERTELMANN, Lohmar (DE); Lorenz BEER, Gerzensee (CH); Christian GEBHARDT, Sinsheim (DE); Abraham VAN DER DRIFT, PB Maasland (NL)

(21) Appl. No.: 18/826,882

(22) Filed: Sep. 6, 2024

Related U.S. Application Data
(63) Continuation-in-part of application No. PCT/EP2023/052325, filed on Jan. 31, 2023.

(30) Foreign Application Priority Data
Mar. 9, 2022 (DE) 10 2022 105 577.9

(51) Int. Cl. C09K 17/48; A01B 79/00; A01G 24/30; A01G 24/48; B01J 20/20; B01J 20/28; B01J 20/30

(52) U.S. Cl. CPC C09K 17/48; A01B 79/00; A01G 24/30; A01G 24/48; B01J 20/20; B01J 20/28011; B01J 20/28045; B01J 20/28085; B01J 20/28092; B01J 20/28095; B01J 20/3042; B01J 20/3064; B01J 20/3085

(57) ABSTRACT

A soil improver for increasing the liquid storage capacity of soils made of a plastic foam, the plastic foam having at least predominantly open cells, characterized in that the plastic foam has a raw density of 5 to 15 kg/m³. The invention also relates to a method for producing a plastic foam of such a soil improver.

### RELATED APPLICATIONS

This application is a continuation of PCT/EP2023/052325, filed on Jan. 31, 2023, which application claims priority to DE 10 2022 105 577.9. The entire disclosures of all the related applications set forth in this section are hereby incorporated by reference in their entireties.

### BACKGROUND

The invention relates to a soil improver for increasing the liquid storage capacity of soils made of a cured plastic foam, wherein the plastic foam has at least predominantly open cells. The invention also relates to a method for producing a plastic foam.

Irrigation of plants often requires significantly more liquid than the plants actually need. This is a major problem, particularly in regions that are already dry. One of the main reasons for inefficient irrigation is the poor liquid storage capacity of soils. Stony and sandy soils in particular, which are often found in arid and semi-arid regions, have a very low liquid storage capacity, meaning that a large proportion of the liquid cannot be used due to runoff, evaporation or seepage. In addition, nutrients that are important for plants are washed out of the soil.

Various products are known to increase the liquid storage capacity of a soil. For example, gel-based water reservoirs absorb water through a chemical reaction, whereby they change their volume. The change in volume of the gel can lead to undesirable cavities in the soil.

Other water reservoirs are based on expanded clay. However, increasing the water storage capacity of a soil by adding expanded clay is ineffective, as even a high material input into the soil results only in a comparatively small increase in liquid storage capacity.

Furthermore, cured hydrophilic foams are also known to increase the liquid storage capacity. DE 10 2004 004 856 B3 discloses a generic liquid storage device for supplying plants with a porous storage material consisting of a foam with a density of 15 kg/m³-60 kg/m³ formed by an urea resin and a surfactant. The foam can be in the form of a molded foam body or preferably in the form of flakes and can be used to store a liquid, in particular water or an aqueous fertilizer solution. It should be embedded as a layer in the soil or in potting soil and essentially surround the roots of the plant to be supplied. The foam is preferably introduced into the soil as a closed layer, whereby the layer is formed by the foam flakes or by one or more plate-shaped foam moldings. It is also possible to mix the foam in the form of flakes with the soil surrounding the root of the plant to be supplied or to distribute it in the soil. The foam has open cells, which gives it hydrophilic properties. This enables it to store liquid and gradually release it to its surroundings, for example to the soil surrounding the root system or directly to the plant root. This foam is intended to provide a liquid reservoir that can be used over a large area.

It should be noted that this Background is not intended to be an aid in determining the scope of the claimed subject matter nor be viewed as limiting the claimed subject matter to implementations that solve any or all of the disadvantages or problems presented above. The discussion of any technology, documents, or references in this Background section should not be interpreted as an admission that the material described is prior art to any of the subject matter claimed herein.

### SUMMARY

The present invention is intended to solve the problem of providing a soil improver with improved properties for storing liquids in soils and with improved suitability for large-scale use.

This problem is solved by a soil improver made from a plastic foam wherein the plastic foam has at least predominantly open cells and has a raw density of 5 to 15 kg/m³. In some implementations, the raw density is 8 to 14.5 kg/m³. In some implementations the raw density is 9 to 12 kg/m³. With any of the above raw densities, the plastic foam may have a compressive strength of 150 to 350 g/cm², 200 to 300 g/cm², or 225 to 275 g/cm². With any of the above combinations of raw density and compressive strengths, the plastic foam may have a cell density 45 to 90 cells/cm or 50 to 75 cells/cm. Any of the above soil improvers may comprise carbon particles such as but not limited to carbon fibers or carbon black. The carbon particles may be provided in an amount greater than or equal to 0.1 weight percent and less than or equal to 10 weight percent. In some implementations, the carbon particles may be provided in an amount greater than or equal to 0.5 weight percent and less than or equal to 5 weight percent.

The problem is also solved by a method for producing any of the above soil improvers, wherein the method comprises mixing a gas into a first liquid to form a first prefoam, wherein the first liquid comprises water and a prepolymer, mixing a gas into a second liquid to form a second prefoam, wherein the second liquid comprises water, a surface-active substance, and a hardener, and mixing the first prefoam and the second prefoam at a mixing ratio of between 40 volume percent of the first prefoam and 60 volume percent of the second prefoam and 60 volume percent of the first prefoam and 40 volume percent of the second prefoam.

### BRIEF DESCRIPTION OF THE DRAWINGS

FIG. 1 is a diagram of a device for manufacturing a soil improver.

### DETAILED DESCRIPTION

The following description and examples illustrate some exemplary implementations, embodiments, and arrangements of the disclosed invention in detail. Those of skill in the art will recognize that there are numerous variations and modifications of this invention that are encompassed by its scope. Accordingly, the description of a certain example embodiment should not be deemed to limit the scope of the present invention.

When the term “plastic foam” or “cured plastic foam” is used here and in the following, the terms associated with it refer to the following understanding of the structure and composition of a plastic foam. Plastic foams consist of a large number of cells with cell spaces that are formed by gas inclusions, whereby the cells can vary significantly in size and shape. In so-called open-cell plastic foams, the cells have open cell walls so that the gas inclusions form an interconnected network. The openings in the cell walls are known as pores and allow the plastic foam to be permeable to gases and liquids. Open cells consist of a large number of cell webs that are formed around the pores and form the outer contour of a cell as a framework.

The raw density of the cured plastic foam of the soil improver according to the invention is 5 to 15 kg/m³, so that the cell webs of the individual cells are very thin. In conjunction with the predominantly open cells, it is possible for the plastic foam to break down into individual fibers, in particular microfibers. Furthermore, the plastic foam itself also has a high liquid storage capacity due to its low raw density, so that it can absorb up to 90% liquid in relation to its own volume if, in addition to fibers, it also partially disintegrates into larger fragments that have several at least partially intact open cells. In addition, the intact plastic foam can permanently store large quantities of a liquid, in particular water, once it has been absorbed, for several months. In this case, 55 to 65% of the originally absorbed liquid remains in the plastic foam.

It was surprisingly found that the low-density plastic foam according to the invention can permanently absorb significantly more liquid than the foam known from DE 10 2004 004 856 B3. As a result, the liquid storage capacity of a soil can be significantly improved over large areas if the soil improver is worked into the soil. In addition, it was surprisingly found that the soil improver according to the invention also interacts directly with the soil and the liquid is retained in the soil by the interaction. For this, it is essential that the soil improver at least partially forms a fiber-soil mixture with the soil as the plastic foam at least partially breaks down into individual fibers and microfibers over time by the action of mechanical force before and/or during incorporation into the soil and/or by means of action in the soil. The soil improver forms a very large contact surface with the soil due to the mixing of the individual fibers in the soil. The large contact surface means that the introduction of a liquid within the fiber-soil mixture creates a capillary effect by means of which a large amount of liquid can be retained in the soil. In particular, the soil improver is suitable for storing water in the soil.

The liquid reservoir known from DE 10 2004 004 856 B3 stores the liquid exclusively directly in the foam itself, so that the liquid storage capacity is defined by the foam volume. Consequently, with this liquid reservoir, it is only possible to store in total only as much additional liquid in the soil as can be directly absorbed by the liquid reservoir.

The soil improver according to the invention also has the advantage that it is degraded in the soil over time by microfungi naturally occurring in the soil and then converted by bacteria, which also occur naturally, into substances that have a fertilizing effect on the soil and can serve as nutrients for plants. The soil improver can act advantageously as a fertilizer until it is completely degraded, which can take place over a period of 6-8 years, for example.

Preferably, the cured plastic foam has a raw density of 8 to 14.5 kg/m³, preferably 9 to 12 kg/m³.

The compressive strength of the plastic foam according to the invention is preferably 150 to 350 g/cm², in particular 200 to 300 g/cm² or especially preferably 225 to 275 g/cm². As a result, the cured plastic foam is comparatively unstable, so that it disintegrates into individual fibers and microfibers even when subjected to a low mechanical force. The compressive strength of the plastic foam can be slightly different between a surface and an inner area of the same plastic foam sample. The information on the compressive strength of the claimed soil improver relates to all areas of the plastic foam. In the present case, the compressive strength is defined as the end of the linear-elastic range under a compressive load at which individual intact cells of the plastic foam fail in such a way that the soil improver is irreversibly deformed.

In order for the plastic foam to break down into as many individual fibers and microfibers as possible and in this way to maximize the contact surface of the soil improver according to the invention with the soil, it is advantageous if the plastic foam has as many cells as possible with a correspondingly large number of cell webs, whereby the proportion of material between the cell spaces should be as low as possible. Therefore, the cell density of the plastic foam is preferably 45 to 90 cells/cm, in particular 50 to 75 cells/cm.

The size of the fibers and microfibers can be influenced by the size of the cell diameter. It is advantageous if the fibers are sufficiently large so that the capillary forces can develop optimally in interaction with the soil. In a preferred embodiment of the soil improver, the cell diameter of all foam cells with a diameter of at least 40 μm is ≤80 μm for 5-15% of these cells, 81-100 μm for 25-35% of these cells, 101-140 μm for 35-45% of these cells, 141-200 μm for 10-20% of these cells, 201-600 μm for 1-10% of these cells and ≥601 μm for <1% of these cells.

In a further preferred embodiment of the soil improver, carbon particles are embedded in the plastic foam. Due to the addition of carbon particles, the fibers released by mechanical action or action in the soil can be longer than fibers of a comparable soil improver without the addition of carbon particles. In addition, the embedded carbon has a fertilizing effect when the soil improver degrades in the soil.

The carbon particles can in particular be carbon fibers and/or carbon black. They are preferably contained in the plastic foam in a proportion of ≥0.1% by weight, in particular in a proportion of ≥0.5% by weight. Furthermore, the proportion of carbon particles in the plastic foam is preferably ≤10% by weight, in particular ≤5% by weight.

If the soil improver according to the invention is to be used in agriculture, it is generally advantageous if it is not toxic itself and if, when it degrades in the soil, no toxic substances are formed which have a harmful effect on living organisms and plants.

A process according to the invention for producing a plastic foam, in particular the soil improver according to the invention described above, is characterized according to claim 9 in that from a liquid A, which contains at least water and a prepolymer, and a liquid B, which contains at least water, a surface-active substance and a hardener, a prefoam A and a prefoam B, are formed by introducing a gas, in particular atmospheric air, into the respective liquid, and the two prefoams are then mixed, the mixing ratio of prefoam A and prefoam B being between 40 vol.-% to 60 vol. % and 60 vol.-% to 40 vol.-%, preferably between 45 vol.-% to 55 vol.-% and 55 vol.-% to 45 vol.-% or, in particular, 47.5 vol.-% to 52.5 vol.-% and 52.5 vol.-% to 47.5 vol.-%.

In a particular embodiment of the process according to the invention, the quantitative ratio of liquid A to liquid B is between 75 vol.-% to 25 vol.-% and 50 vol.-% to 50-% by volume.

By introducing the gas into liquids A and B, it is possible to control the number of cells and the cell diameter of the plastic foam of the soil improver according to the invention that is formed after mixing and to influence the cell structure. The gas is introduced into liquid A and liquid B respectively, whereby a high number of bubble nuclei is provided in the liquids. In this way, two prefoams are formed which, when mixed, form a plastic foam with a high cell density due to the high number of bubble nuclei.

Preferably, the prefoam A and the prefoam B react with each other by mixing in a tubular reaction chamber. The reaction chamber advantageously has at least one open end through which the plastic foam produced by the reaction can emerge and subsequently harden. Furthermore, the reaction chamber can have a reaction chamber length in the longitudinal direction and a substantially circular cross-section with a reaction chamber diameter. The ratio of reaction chamber diameter to reaction chamber length is preferably between 1 to 50 and 1 to 200, preferably between 1 to 80 and 1 to 120 and particularly preferably 1 to 100. The reaction chamber diameter is in particular less than 200 mm, preferably between 10 and 50 mm.

The volume flow of the liquids can be, respectively, between 50 and 150 ml per mm of the reaction chamber diameter, preferably 100 ml per mm of the reaction chamber diameter.

In a further preferred embodiment of the process, the prefoam A and the prefoam B can each be fed to the reaction chamber via a separate feed channel. The feed channels have a specific channel cross-sectional area, the ratio of which to the reaction chamber cross-sectional area is advantageously between 1.0 to 2.0 and 1.0 to 0.5, preferably 1 to 1. Furthermore, it is advantageous if the ratio of a channel length of the feed channels to the reaction chamber diameter is between 2 to 1 and 4 to 1, preferably 3 to 1. The geometry and dimensions of the reaction chamber and the feed channels ensure that a plastic foam with the required cell diameters and the required cell density is formed before it emerges from the reaction chamber.

Preferably, the mixing of the prefoam A and the prefoam B as well as the conveying of the reacting prefoams and the resulting plastic foam can be carried out automatically by the inflowing prefoams. This is advantageous because in this way no further devices, which could have an undesirable influence on the production of the soil improver, are required to carry out these processes. The gas, which is preferably introduced into the liquids using a compressed air device, can be introduced into the liquids at a pressure of 1 to 2.5 bar, in particular 1 to 2.25 bar or especially preferably 1 to 2 bar, to ensure that the foaming process is stable.

The prepolymer contained in the liquid A is chemically and/or thermally crosslinkable, so that a soil improver can be formed from a cured plastic foam. In a preferred embodiment of the method according to the invention, the prepolymer can be a urea-formaldehyde, which serves as a carrier material and ensures that the plastic foam retains its structure in a cured state. It is advantageous if the proportion of urea-formaldehyde in relation to the water contained in the liquid A—is preferably ≥10 wt.-%, in particular ≥15 wt.-% or particularly preferably ≥22 wt.-%. Furthermore, it is preferred if the proportion of urea-formaldehyde in relation to the water contained in the liquid A is preferably ≤35 wt.-%, in particular ≤30 wt.-% or particularly preferably ≤27 wt.-%.

Furthermore, the liquid A may contain other substances that can be used, for example, to influence the density and compressive strength of the cured plastic foam. As a preferred example, liquid A is mixed with urea. It is advantageous if the proportion of urea in relation to the water contained in the liquid A is preferably ≥0.5 wt.-%, in particular ≥ 0.75 wt.-% or particularly preferably ≥1 wt.-%. Furthermore, it is preferred if the proportion of urea in relation to the water contained in the liquid A is preferably ≤5 wt.-%, in particular ≤3 wt.-% or particularly preferably ≤2 wt.-%.

In a further preferred embodiment of the process according to the invention, the surface-active substance in the liquid B is a surfactant which enables foam formation. In particular, but not exclusively, anionic surfactants such as alkylbenzene sulfonates, fatty alcohol ether sulfates or fatty alcohol sulfates may be considered as surfactants. It is advantageous if the proportion of the surfactant in relation to the water contained in the liquid B is preferably ≥5 wt.-%, in particular ≥7.5 wt.-% or particularly preferably ≥10 wt.-%. Furthermore, it is preferred if the proportion of surfactant in relation to the water contained in the liquid B is preferably ≤20 wt.-%, in particular ≤15 wt.-% or particularly preferably ≤ 12 wt.-%.

It is also preferable if the hardener contained in the liquid B is an acid catalyst which causes the crosslinking of the prepolymer and thus the stabilization of the plastic foam. Suitable acid catalysts include, but are not limited to, phosphoric acid, citric acid and p-toluene sulfonic acid. It is advantageous if the proportion of the acid catalyst in relation to the water contained in the liquid B is preferably ≥15 wt.-%, in particular ≥20 wt.-% or particularly preferably ≥25 wt.-%. Furthermore, it is preferred if the proportion of the acid catalyst in relation to the water contained in the liquid B is preferably ≤40 wt.-%, in particular ≤35 wt.-% or particularly preferably ≤30 wt.-%.

Furthermore, in a preferred embodiment, the liquid B may contain resorcinol as a further catalyst. It is advantageous if the proportion of resorcinol in relation to the water contained in the liquid B is preferably ≥0.5 wt.-%, in particular ≥1 wt.-% or particularly preferably ≥2 wt.-%. Furthermore, it is preferred if the proportion of resorcinol in relation to the water contained in the liquid B is preferably ≤10 wt.-%, in particular ≤5 wt.-% or particularly preferably ≤3 wt.-%.

Furthermore, it is advantageous if the process temperature of the method according to the invention is between 30° C. and 55° C., in particular 35° C. and 50° C. or particularly preferably 40° C. and 45° C.

In the following, an example of the production of the soil improver according to the invention from the cured plastic foam is described.

The properties of the soil improver were determined using the following methods:

Determination of the raw density: The raw density ρ is the density of the cured plastic foam based on the mass and the total volume resulting from the sum of the volume of the solid material components V_{fest} and the volume of the cell spaces V_{Zel} of the plastic foam. The raw density was calculated using the following formula ρ=m/(V_{fest}+V_{Zel}).

Determination of compressive strength: The compressive strength of the cured plastic foam was determined by loading a cuboid sample of the plastic foam on one of its surfaces under compressive stress until plastic deformation occurred. The foam sample was loaded with a circular punch with an area of 1 cm², whereby the surface of the plastic foam that was loaded with the punch was significantly larger than the surface of the punch.

Determination of the cell density: The cell density was determined by placing a line grid of four horizontal and five vertical lines in each of ten images of different sections of a foam surface measuring slightly more than 3*4 mm, which were taken with a microscope camera with a resolution of 48 megapixels, the distance between which corresponds to a distance of 1 mm on the surface of the recorded foam. The recorded foam surfaces are surfaces of foam pieces cut out from the inside of a produced plastic foam. The orientation of the cut surface of the cut-out foam piece within the produced plastic foam is irrelevant for determining the cell density. The outer surface of the plastic foam produced is not taken into account when determining the cell density. The cells that at least partially intersected the line were counted along each line. Only cells with a cell diameter greater than or equal to 40 μm were taken into account. The cell counts determined in this way were used to calculate an average cell count across all lines of all image sections. The mean cell count was converted into the number of cells per centimeter by adding the known length of the lines, which is defined here as cell density. Foam defects, such as cavities that ran through several cell walls and cell webs, were not considered as cells.

Determination of the cell diameter: To determine the cell diameter, the diameter was estimated by calculating the mean value of the largest and smallest distance between two opposing cell walls running through the approximate center of gravity of the cell as the cell diameter. The error resulting from the estimation is negligible due to the small number of cells whose mean diameter is around 40 μm. Alternatively, the mean diameter can be determined by determining the area of a cell using image analysis software and deriving the diameter from the area, assuming that the area is that of an ideal circular surface.

To obtain the soil improver from a hardened plastic foam, liquid A and liquid B were first produced separately and kept ready in containers.

Liquid A was prepared by mixing distilled water with, in relation to the amount of distilled water, 25 wt.-% of urea-formaldehyde (Basopor® 293) and 1 wt.-% of urea.

Liquid B was prepared by mixing distilled water with, in relation to the amount of distilled water, 11 wt.-% of an anionic surfactant, 27 wt.-% of phosphoric acid and 2 wt.-% of resorcinol.

First, a prefoam was formed from each liquid by introducing atmospheric air into the liquids at a flow rate of 90 l/min and 1.5 bar using a compressed air device. The liquids were added in a ratio of 50 vol.-% to 50 vol.-% and with a volume flow of 3 l/min each.

Subsequently, the prefoam A and the prefoam B were fed into a reaction chamber in a ratio of 50 vol.-% to 50 vol.-%. Inside the reaction chamber, the prefoams were mixed and conveyed out of the reaction chamber for curing. The decisive factor was that the liquid B or the prefoam B already contained the hardener and the surfactant, so that the formation of the plastic foam began immediately upon mixing with the prefoam A, with curing starting at the same time. During production, the process temperature was approximately 42° C.

The ratio of the length of the feed channels in which the liquids were pre-expanded and the reaction chamber diameter was 3 to 1. Furthermore, the ratio of the feed channel cross-section to the reaction chamber cross-section was 1 to 1, with the feed channel diameter and the reaction chamber diameter each being 20 mm. The ratio of reaction chamber diameter to reaction chamber length was 1 to 100. The feed channels and the reaction chamber can be designed as hoses.

The cured plastic foam of the soil improver according to the invention produced by the exemplary method described had a raw density of 12.3 kg/m³, a compressive strength of 249.3 g/cm², measured on one surface of the plastic foam, and a cell density of 59 cells/cm.

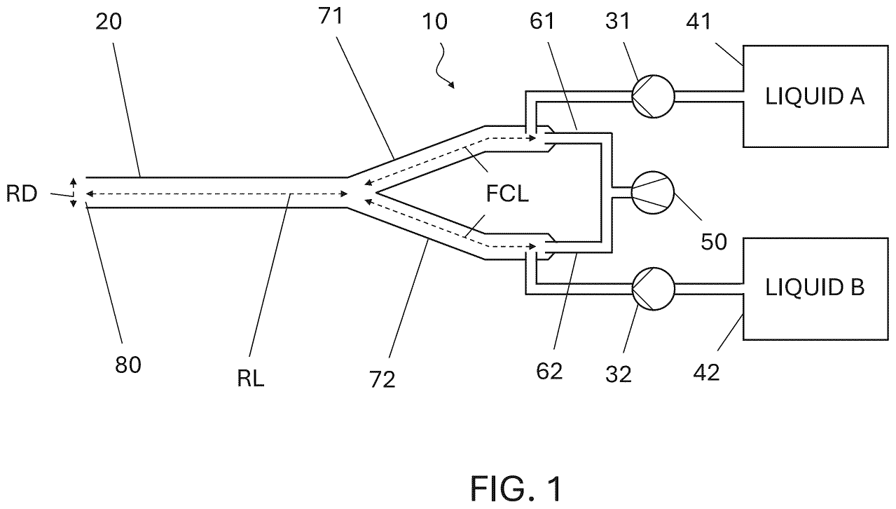

The method according to the invention for producing the cured plastic foam, in particular the soil improver according to the invention, can be carried out, for example, using a device shown in FIG. 1.

The device 10 shown in FIG. 1 has a reaction chamber 20 to which a liquid A is fed from the container 41 via the metering pump 31 and a liquid B is fed from the container 42 via the metering pump 32. A compressed air device 50 is arranged between the reaction chamber 20 and the metering pumps 31, 32, which introduces atmospheric air into the liquid A via the gas duct 61 and into the liquid B via the gas duct 62, thereby prefoaming the liquids before they are fed into the reaction chamber 20, whereby a prefoam A and a prefoam B are formed. Subsequently, the prefoams flow into the reaction chamber 20 via the feed channels 71 and 72 due to the pressure of the compressed air device 50 and the subsequent flow of liquids and prefoams. There, the prefoams mix in such a way that they react with each other, whereby the formation of a plastic foam begins. The resulting plastic foam exits through an open end 80 of the reaction chamber 20 and then hardens. The reacting prefoams and the plastic foam resulting from the reaction are automatically moved in the reaction chamber 20 in the direction of the open end 80 by the inflowing prefoams, so that no device is required for conveying the plastic foam.

The reaction chamber 20 has a reaction chamber cross-sectional area, which can, for example, correspond to the respective channel cross-sectional area of the feed channels 71, 72. Furthermore, the reaction chamber 20 has a reaction chamber length RL, whereby the ratio of a reaction chamber diameter RD to the reaction chamber length RL can be 1 to 100, for example. A ratio of a feed channel length FCL to the reaction chamber diameter RD can also be 3 to 1, for example. In this way, a plastic foam with a cell structure can form in the reaction chamber 20, which leads to the soil improver according to the invention.

### LIST OF REFERENCE NUMBERS

10 Device
20 Reaction chamber
31 Dosing pump
32 Dosing pump
41 Container
42 Container
50 Compressed air device
61 Gas duct
62 Gas duct
71 Feed channel
72 Feed channel
80 open end
RL Reaction chamber length
RD reaction chamber diameter
FCL Feed channel length

What is claimed is:

1. A soil improver for increasing the liquid storage capacity of soils, wherein the soil improver comprises a plastic foam, wherein the plastic foam has at least predominantly open cells, and wherein the plastic foam has a raw density of 5 to 15 kg/m³.

2. The soil improver according to claim 1, wherein the plastic foam has a raw density of 8 to 14.5 kg/m³.

3. The soil improver according to claim 1, wherein the plastic foam has a compressive strength of 150 to 350 g/cm².

4. The soil improver according to claim 1, wherein the plastic foam has a cell density of 45 to 90 cells/cm.

5. The soil improver according to claim 1, wherein a distribution of cell diameters of the cells of the plastic foam with a cell diameter of at least 40 μm is:
5-15% of these cells ≤80 μm
25-35% of these cells 81-100 μm
35-45% of these cells 101-140 μm
10-20% of these cells 141-200 μm
1-10% of these cells 201-600 μm
<1% of these cells ≥601 μm.

6. The soil improver according to claim 1, further comprising carbon particles embedded in the plastic foam.

7. The soil improver according to claim 6, wherein the carbon particles embedded in the plastic foam comprise one or both of carbon fibers and carbon black.

8. The soil improver according to claim 6, wherein the proportion of carbon particles in the plastic foam is ≥0.1% by weight.

9. The soil improver according to claim 8, wherein the proportion of carbon particles in the plastic foam is ≤10% by weight.

10. A method for producing the soil improver of claim 1, the method comprising:
mixing a gas into a first liquid to form a first prefoam, wherein the first liquid comprises water and a prepolymer;
mixing a gas into a second liquid to form a second prefoam, wherein the second liquid comprises water, a surface-active substance, and a hardener; and
mixing the first prefoam and the second prefoam at a mixing ratio of between 40 volume percent of the first prefoam and 60 volume percent of the second prefoam and 60 volume percent of the first prefoam and 40 volume percent of the second prefoam.

11. The method according to claim 10, wherein the mixing ratio of the first prefoam and the second prefoam is between 47.5 volume percent of the first prefoam and 52.5 volume percent of the second prefoam and 52.5 volume percent of the first prefoam and 47.5 volume percent of the second prefoam.

12. The method according to claim 10, wherein the quantitative ratio of the first liquid and second liquid is between 75 volume percent of the first liquid and 25 volume percent of the second liquid and 50 volume percent of the first liquid and 50 volume percent of the second liquid.

13. The method according to claim 10, comprising introducing compressed air into the respective first and second liquids at a pressure of 1 to 2.5 bar.

14. The method according to claim 10, comprising mixing the first prefoam and the second prefoam in a tubular reaction chamber with an open end.

15. The method according to claim 14, wherein the reaction chamber has a substantially circular cross-section with a reaction chamber diameter, the ratio of the reaction chamber diameter to a reaction chamber length of the reaction chamber being between 1:50 and 1:200.

16. The method according to claim 15, wherein the first prefoam and the second prefoam are each fed to the reaction chamber via a feed channel having a channel cross-sectional area, and wherein the ratio of each of the feed channel cross-sectional areas to the reaction chamber cross-sectional area being between 1:2 and 1:0.5.

17. The method according to claim 10, wherein the mixing of the first prefoam and the second prefoam and the conveying of the prefoams reacting with one another and of the resulting plastic foam in the reaction chamber is carried out automatically by the inflowing prefoams.

18. The method according to claim 10, wherein the prepolymer is a urea-formaldehyde, and wherein the proportion of the urea-formaldehyde in the first liquid relative to the water in the first liquid is 10 weight percent to 35 weight percent.

19. The method according to claim 10, comprising admixing a urea with the first liquid, wherein the proportion of urea in the first liquid relative to the water in the first liquid is ≥0.5 weight percent and ≤5 weight percent.

20. The method according to claim 10, wherein the surface-active substance is a surfactant, and wherein the proportion of the surfactant in the second liquid with respect to the water contained in the second liquid is ≥5 weight percent and ≤20 weight percent.

21. The method according to claim 10, wherein the hardener is an acid catalyst, and wherein the proportion of the acid catalyst in the second liquid with respect to the water contained in the second liquid is ≥15 weight percent and ≤40 weight percent.

22. The method according to claim 10, wherein the second liquid comprises resorcinol, and wherein the proportion of resorcinol in the second liquid with respect to the water contained in the second liquid is ≥0.5 weight percent and ≤5 weight percent.

23. The method according to claim 10, wherein the mixing of the first prefoam and the second prefoam is performed at a temperature between 30° C. and 55° C.

24. A method of treating soil comprising mixing a predominantly open cell plastic foam having a raw density of 5 to 15 kg/m³ into the soil to be treated.

25. The method of claim 24, wherein the soil improver at least partially forms a fiber-soil mixture with the soil as the open cell plastic foam at least partially breaks down into individual fibers over time by the action of mechanical force before and/or during incorporation into the soil and/or by means of action in the soil.
